(19) United States
(12) Patent Application Publication
(10) Pub. No.: US 2012/0079682 A1
(43) Pub. Date: Apr. 5, 2012

(54) ADJUSTABLE HINGE ASSEMBLY FOR A GLASS DOOR

(76) Inventor: Ko-Ming CHENG, Pingtung City (TW)

(21) Appl. No.: 12/896,374

(22) Filed: Oct. 1, 2010

(51) Int. Cl. E05D 7/12

(52) U.S. Cl. 16/252

(57) ABSTRACT

An adjustable hinge assembly for a glass door has a frame fastening device, a door clamping device and an adjustable device. The frame fastening device is mounted securely to a doorframe and has two pivot sections protruding from the frame fastening device. The door clamping device clamps a glass door. The adjustable device has two pins mounted between and respectively pressing against the pivot sections. Because two pins respectively press against the pivot sections, pressing forces provided by the pins are sufficient and the structure of the adjustable hinge assembly for a glass door is enhanced. Accordingly, to frequently adjust the position of the glass door relative to the doorframe is unnecessary.

### BACKGROUND OF THE INVENTION

1. Field of the Invention

The present invention relates to an adjustable hinge assembly for a glass door, and more particularly to an adjustable hinge assembly for a glass door to steadily adjust a position of a glass door relative to a doorframe.

2. Description of Related Art

A conventional hinge assembly for a glass door is used to connect a glass door to a doorframe and has a frame bracket, an adjustable device and two plates. The frame bracket can be secured on the doorframe. The adjustable device is connected with the frame bracket and the plates to allow the plates to pivot relative to the frame bracket. The plates are connected securely to each other via bolts and clamp the glass door. Accordingly, the glass door can be pivoted relative to the doorframe via the conventional hinge assembly.

However, the glass door may be misaligned with and cannot completely close the doorframe due to an assembling inaccuracy of the conventional hinge assembly. The conventional hinge assembly always has a capability of adjusting a position of the glass door relative to the doorframe and achieved by a single adjusting screw. However, the conventional hinge assembly is not stable because the single screw cannot provide a sufficient force to the frame bracket. Therefore, the glass door should be repositioned by the conventional hinge assembly frequently, and this is inconvenient.

To overcome the shortcomings, the present invention tends to provide an adjustable hinge assembly for a glass door to mitigate the aforementioned problems.

### SUMMARY OF THE INVENTION

The main objective of the invention is to provide an adjustable hinge assembly for a glass door to steadily adjust a position of a glass door relative to a doorframe.

An adjustable hinge assembly for a glass door has a frame fastening device, a door clamping device and an adjustable device. The frame fastening device is mounted securely to a doorframe and has two pivot sections protruding from the frame fastening device. The door clamping device clamps a glass door. The adjustable device has two pins mounted between and respectively pressing against the pivot sections. Because two pins respectively press against the pivot sections, pressing forces provided by the pins are sufficient and the structure of the adjustable hinge assembly for a glass door is enhanced. Accordingly, to frequently adjust the position of the glass door relative to the doorframe is unnecessary.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an adjustable hinge assembly for a glass door in accordance with the present invention;

FIG. 2 is an exploded perspective view of the adjustable hinge assembly for a glass door in FIG. 1;

FIG. 3 is an enlarged front view in partial section of the adjustable hinge assembly for a glass door in FIG. 1 showing an adjusting screw pressing against two pins;

FIG. 4 is an enlarged side view in partial section of the adjustable hinge assembly for a glass door in FIG. 1 showing the adjusting screw pressing against the pins;

FIG. 5 is an enlarged front view in partial section of the adjustable hinge assembly for a glass door in FIG. 3 showing the adjusting screw being away from a position where presses the pins;

FIG. 6 is an enlarged side view in partial section of the adjustable hinge assembly for a glass door in FIG. 4 showing the adjusting screw being away from a position where presses the pins;

FIG. 7 is an operational view of the adjustable hinge assembly for a glass door in FIG. 1;

FIG. 8 is an operational top view of the adjustable hinge assembly for a glass door in FIG. 1, wherein a position of a glass door relative to a doorframe is adjusted; and

FIG. 9 is an enlarged perspective view of the adjustable hinge assembly for a glass door in FIG. 1.

### DETAILED DESCRIPTION OF PREFERRED EMBODIMENT

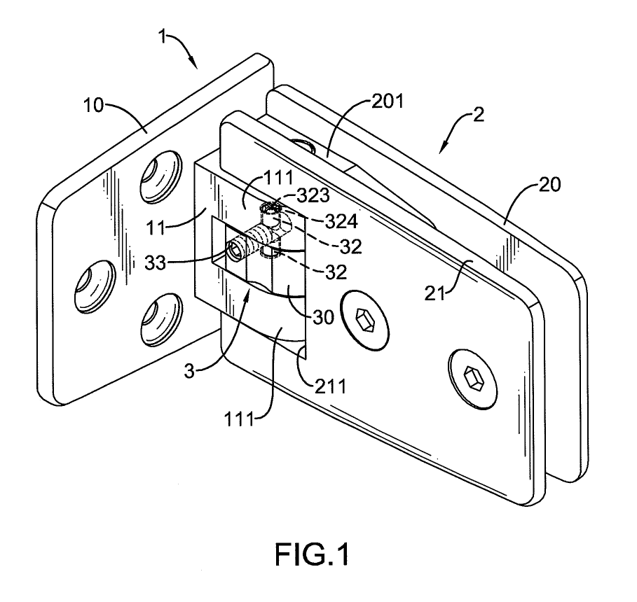

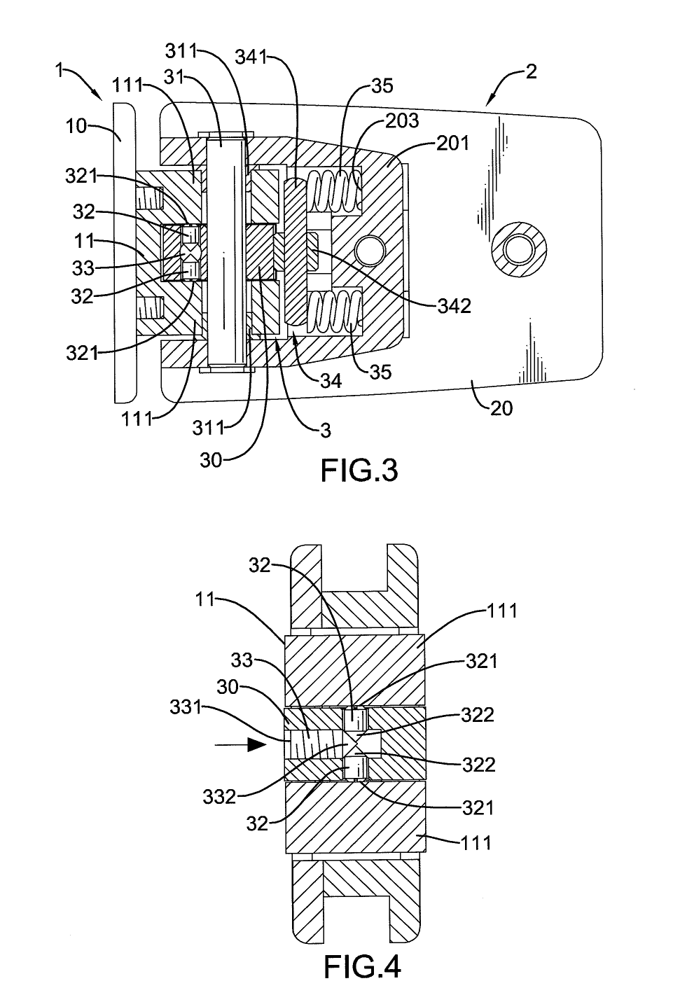

With reference to FIGS. 1 to 4, an adjustable hinge assembly for a glass door in accordance with the present invention comprises a frame fastening device 1, a door clamping device 2 and an adjustable device 3.

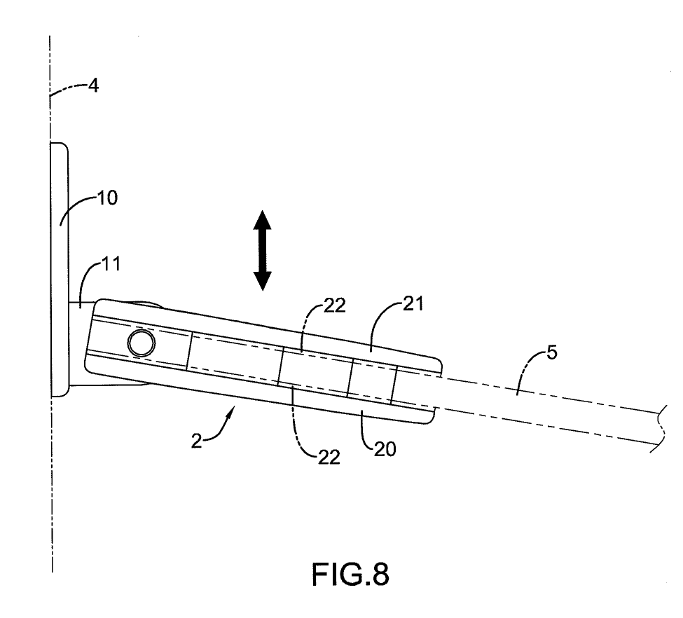

The frame fastening device 1 has a first bracket 10 and a second bracket 11. The first bracket 10 has multiple bracket holes which are formed through the first bracket 10 and through which bolts are respectively mounted, and the frame fastening device 1 can be secured on a doorframe 4 with the first bracket 10 and the bolts as shown in FIG. 8.

The second bracket 11 is mounted on the first bracket 10 and has two pivot sections 111, a chunk space 112 and two section holes 113. The pivot sections 111 are separated from and parallel to each other. One of the pivot sections 111 is located above the other. The chunk space 112 is formed between the pivot sections 111. The section holes 113 are respectively formed through the pivot sections 111 and align with each other.

Preferably, the first bracket 10 and the second bracket 11 are two separate parts combined securely with each other via bolts 12. Alternatively, the first bracket 10 and the second bracket 11 may be formed as a single part. The present invention does not limit the implementation of the frame fastening device 1.

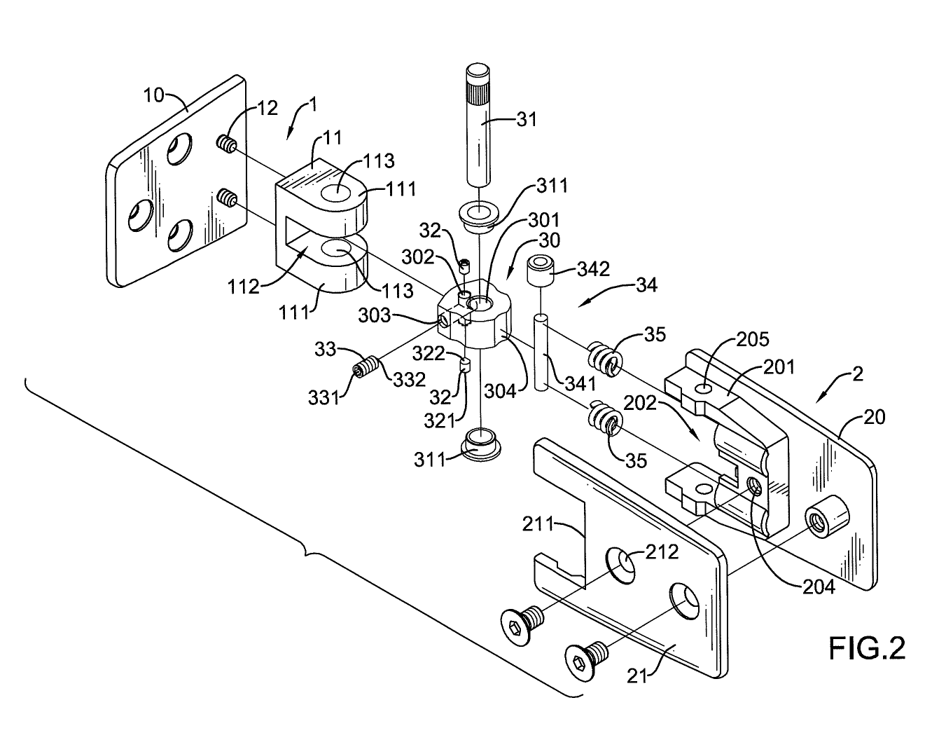

With reference to FIGS. 2 to 4, the door clamping device 2 has a first plate 20 and a second plate 21. The first plate 20 has a side surface and a positioning section 201, a first notch 202, two spring recesses 203, multiple threaded holes 204 and a pivot hole 205.

The positioning section 201 protrudes from the side surface of the first plate 20. The first notch 202 is formed in the positioning section 201, holds the pivot sections 111 and has a bottom. The spring recesses 203 are respectively formed in the bottom of the first notch 202. The spring recesses 203 are separated from and parallel to each other. One of the spring recesses 203 is located above the other. The threaded holes 204 are formed in the first plate 20. The pivot hole 205 is formed through the positioning section 201 and communicates with the first notch 202.

The second plate 21 is connected securely with the first plate 20 to clamp a glass door 5 as shown in FIG. 8. The second plate 21 has an end, a side surface, a second notch 211 and multiple plate holes 212. The side surface of the second plate 21 faces the positioning section 201. The second notch 211 is formed in the end of the second plate 21, corresponds to and aligns with the first notch 202 of the first plate 20 and holds the pivot sections 111. The plate holes 212 are formed though the second plate 21 and respectively align with the threaded holes 204.

With reference to FIGS. 2 to 4, the adjustable device 3 is mounted between the frame fastening device 1 and the door clamping device 2 to connect the door clamping device 2 pivotally with the frame fastening device 1 and has a chunk 30, a pivot 31, two bushings 311, two pins 32, an adjusting screw 33, a positioning unit 34 and two springs 35.

The chunk 30 is mounted in the chunk space 112 and has an outer surface, a chunk hole 301, an aperture 302, an adjusting hole 303 and three concave sections 304.

The outer surface of the chunk 30 may be arcuated. The chunk hole 301 is longitudinally formed through the chunk 30. The aperture 302 is longitudinally formed through the chunk 30 at a position beside the chunk hole 301. The adjusting hole 303 is threaded, is radially formed in the chunk 30 and communicates with the aperture 302. The concave sections 304 are at intervals formed longitudinally in the outer surface of the chunk 30.

The pivot 31 is longitudinally mounted in the pivot hole 205 and is mounted through the section holes 113 and the chunk hole 301. The bushings 311 are respectively mounted in the section holes 113, are inserted into the chunk hole 301 and are mounted around the pivot 31.

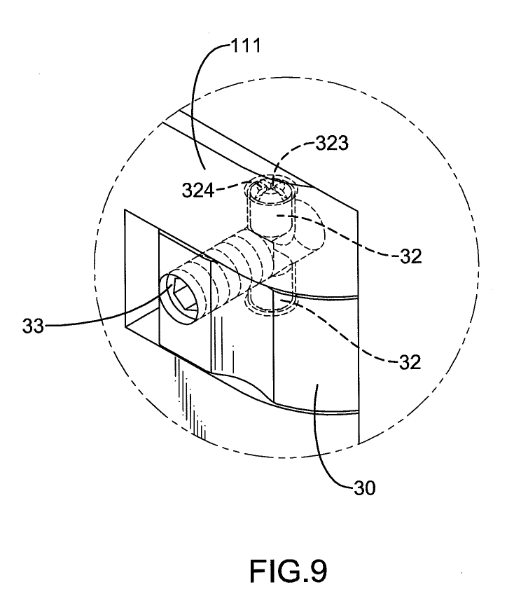

With further reference to FIGS. 1 and 9, the pins 32 are mounted in the aperture 302. Each pin 32 has an abutting end 321, a conical end 322, a cross groove 323 and four corners 324. The abutting ends 321 of the pins 32 respectively face and abut the pivot sections 111. The conical ends 322 are respectively opposite to the abutting ends 321 of the pins 32 and face each other. The cross grooves 323 are respectively formed in the abutting ends 321. The corners 324 of each pin 32 are formed at the corresponding abutting end 321 beside the cross groove 323 and provide friction to make the pins 32 abutting tightly with the pivot sections 111.

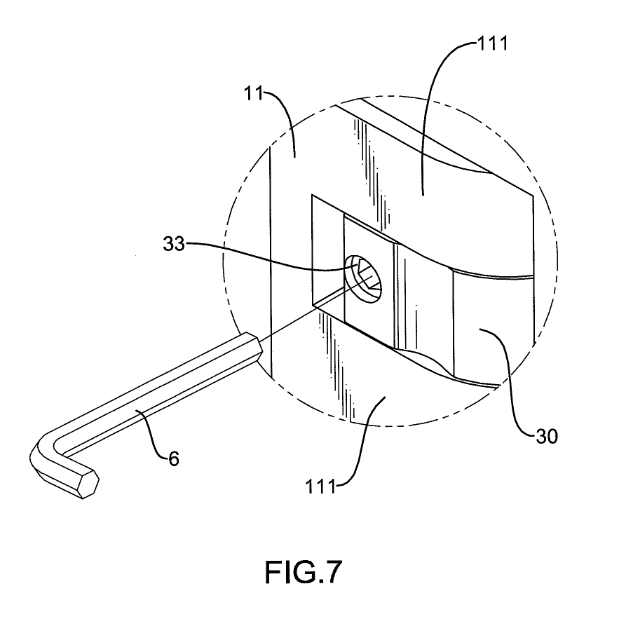

The adjusting screw 33 is screwed into the adjusting hole 303 and has a tool end 331 and a conical pressing end 332. The tool end 331 has a tool recess formed in the tool end 331, and a tool 6 can be inserted into the tool recess to rotate the adjusting screw 33 as shown in FIG. 7. A cross sectional shape of the tool recess can be linear, cross or hexagonal, to fit with different tools for rotating the adjusting screw 33.

The conical pressing end 332 is opposite to the tool end 331 and presses against the conical ends 322 of the pins 32. With the conical pressing end 332 and the conical ends 322, the pressing end 332 can push the conical ends 322 of the pins 32 to make the abutting ends 321 respectively abutting tightly with the pivot sections 111. With the tight abutment between the abutting ends 321 and the second bracket 11, the chunk 30 is kept from rotating relative to the pivot 31.

The positioning unit 34 abuts the outer surface of the chunk 30. Preferably, the positioning unit 34 has a rod 341 and a wheel 342. The rod 341 has two ends and a central segment. The central segment of the rod 341 is formed between the ends of the rod 341. The wheel 342 is rotatably mounted around the central segment of the rod 341 and abuts the outer surface of the chunk 30. The wheel 342 can selectively abut one of the concave sections 304. The springs 35 are mounted in the first notch 202. Each spring 35 has a first end and a second end. The first ends of the springs 35 are respectively mounted in the spring recesses 203 and abut the first plate 20. The second ends are respectively opposite to the first ends of the springs 35 and respectively abut the ends of the positioning rod 341. The springs 35 provide pressing forces to push the positioning unit 34 to abut the chunk 30.

With reference to FIGS. 1, 7 and 8, to connect the glass door 5 pivotally with the doorframe 4 with the adjustable hinge assembly in accordance with the present invention, the first plate 20 and the second plate 21 clamp two side surfaces of the glass door 5 and are connected securely to each other via bolts. Two pads 22 can be further respectively mounted on the side surfaces of the glass door 5 and be clamped by the first plate 20 and the second plate 21. The first bracket 10 is securely connected to the doorframe 4 with bolts. Consequently, the glass door 5 is connected pivotally to the doorframe 4.

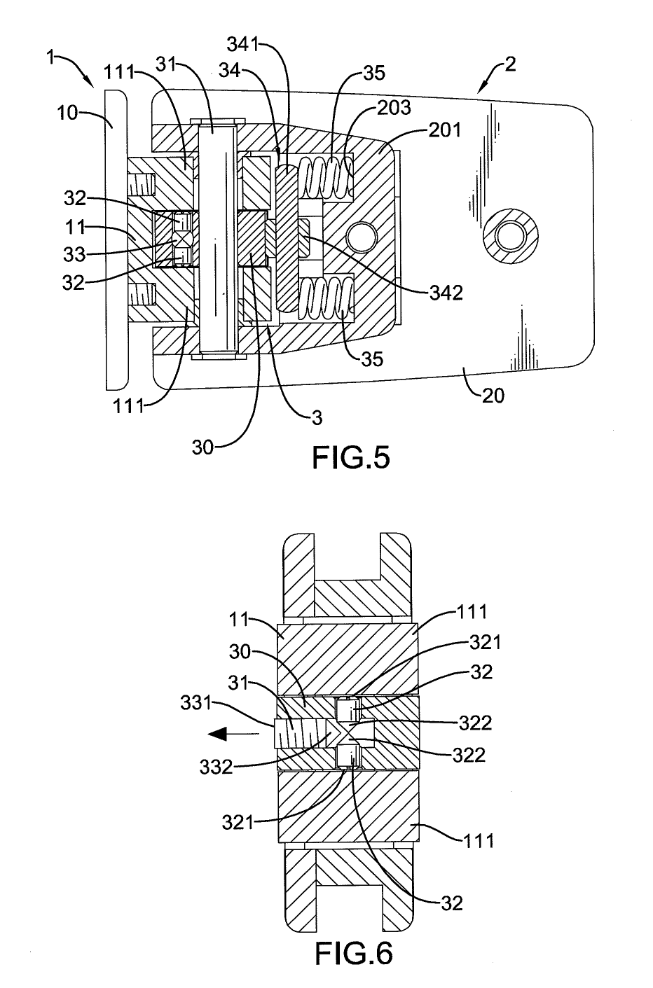

With reference to FIGS. 1 and 7, to align the glass door 5 precisely with the doorframe 4, the tool 6 is inserted into the tool recess in the tool end of the adjusting screw 33 to rotate the adjusting screw 33 to make the adjusting screw 33 moving away from the pins 32. With further reference to FIGS. 5, 6 and 8, when the pressing end 332 of the adjusting screw 33 is moved away from the conical ends 322 of the pins 32, the abutting ends 321 are kept from pressing against the pivot sections 111. Thus, the chunk 30 can be rotated relative to the second bracket 11. When the glass door 5 is rotated, the first plate 20 connected securely with the glass door 5 is also rotated. The rotated first plate 20 makes the springs 35, the positioning unit 34 and the chunk 30 rotating with the glass door 5. Accordingly, the position of the chunk 30 relative to the second bracket 11 can be changed, and the position of the glass door 5 relative to the doorframe 4 can also be adjusted to precisely align the glass door 5 with the doorframe 4 and to make the glass door 5 having a capability of completely closing the doorframe 4.

After the adjusting screw 33 is screwed into the adjusting hole 303 with the tool 6, the pressing end 332 of the adjusting screw 33 presses against the conical ends 322 of the pins 32 again. Consequently, the abutting ends 321 respectively tightly press against the pivot sections 111 and two shallow recesses are respectively formed in the pivot sections 111. With the corners 324 biting the inner surfaces of the shallow recesses of the pivot sections 111, the chunk 30 can be secured in the chunk space 112. An adjustment of the glass door 5 relative to the doorframe 4 is achieved.

Additionally, when glass door 5 is opened or closed relative to the doorframe 4, the glass door 5 is pivoted relative to the doorframe 4 with a center at the pivot 31. During the pivotal rotation of the glass door 5, the wheel 342 will be moved along the outer surface of the chunk 30. With the engagement between the wheel 342 with one of the concave sections 304 in the chunk 30, the glass door 5 can be positioned at different positions relative to the doorframe 4.

From the above description, it is noted that the present invention has the following advantage:

1. Enhanced structure:

Because two pins 32 are mounted on the chuck 30 for holding the chunk 30 at a position relative to the pivot sections 111 of the second bracket 11, the pressing forces provided by the pins 32 are sufficient and the structure of the adjustable hinge assembly for a glass door is enhanced and stable. Accordingly, to frequently adjust the position of the glass door 5 relative to the doorframe 4 is unnecessary. Moreover, the cross grooves 323 and the corners 324 defined in the pins 32 can provide biting forces and sufficient friction to make the pins 32 pressing tightly with the pivot sections 111.

2. Smooth relative rotation between the glass door 5 and the doorframe 4:

With the wheel 342 being rotatably mounted around the central segment of the rod 341 and abutting the chunk 30, the rotation between the glass door 5 and the doorframe 4 is smooth. Moreover, the concave sections 304 can provide a positioning effect to the glass door 5 relative to the doorframe 4.

What is claimed is:

1. An adjustable hinge assembly for a glass door comprising:
a frame fastening device having
a first bracket; and
a second bracket mounted on the first bracket and having two pivot sections which are separated from and parallel to each other;
a door clamping device having
a first plate having a positioning section protruding from the first plate; and
a second plate connected securely with the first plate to clamp the glass door;
an adjustable device mounted between the frame fastening device and the door clamping device to connect the door clamping device pivotally with the frame fastening device and having
a chunk mounted between the pivot sections and having
an outer surface;
an aperture longitudinally formed through the chunk; and
an adjusting hole being threaded, radially formed in the chunk and communicating with the aperture;
a pivot longitudinally mounted in the positioning section and mounted through the pivot sections and the chunk beside the aperture;
two pins mounted in the aperture, each pin having
an abutting end facing one of the pivot sections; and
a conical end opposite to the abutting end;
an adjusting screw screwed into the adjusting hole and having a conical pressing end pressing against the conical ends of the pins;
a positioning unit abutting the outer surface of the chunk; and
two springs mounted in the door clamping device, each spring having
a first end abutting the door clamping device; and
a second end opposite to the first end of the springs and abutting the positioning unit.

2. The adjustable hinge assembly for a glass door as claimed in claim 1, wherein the outer surface of the chunk is arcuated and the chunk has three concave sections at intervals formed longitudinally in the outer surface of the chunk;
the positioning unit has
a rod having
two ends respectively pressed against by the springs; and
a central segment formed between the ends of the rod; and
a wheel rotatably mounted around the central segment of the rod and abutting the outer surface of the chunk.

3. The adjustable hinge assembly for a glass door as claimed in claim 1, wherein the first bracket and the second bracket are two separate parts combined securely with each other via bolts.

4. The adjustable hinge assembly for a glass door as claimed in claim 2, wherein the first bracket and the second bracket are two separate parts combined securely with each other via bolts.

5. The adjustable hinge assembly for a glass door as claimed in claim 1, wherein
the first plate has a first notch formed in the positioning section and holding the pivot sections;
the second plate has an end and a second notch formed in the end of the second plate and holding the pivot sections; and
the springs are mounted in the first notch and the first ends of the springs abut the first plate.

6. The adjustable hinge assembly for a glass door as claimed in claim 2, wherein
the first plate has a first notch formed in the positioning section and holding the pivot sections;
the second plate has an end and a second notch formed in the end of the second plate and holding the pivot sections; and
the springs are mounted in the first notch and the first ends of the springs abut the first plate.

7. The adjustable hinge assembly for a glass door as claimed in claim 3, wherein
the first plate has a first notch formed in the positioning section and holding the pivot sections;
the second plate has an end and a second notch formed in the end of the second plate and holding the pivot sections; and
the springs are mounted in the first notch and the first ends of the springs abut the first plate.

8. The adjustable hinge assembly for a glass door as claimed in claim 4, wherein
the first plate has a first notch formed in the positioning section and holding the pivot sections;
the second plate has an end and a second notch formed in the end of the second plate and holding the pivot sections; and
the springs are mounted in the first notch and the first ends of the springs abut the first plate.

9. The adjustable hinge assembly for a glass door as claimed in claim 1, wherein each pin has
a cross groove formed in a corresponding abutting end; and
four corners formed at the corresponding abutting end beside the cross groove.

10. The adjustable hinge assembly for a glass door as claimed in claim 8, wherein each pin has
a cross groove formed in a corresponding abutting end; and
four corners formed at the corresponding abutting end beside the cross groove.
